(19) United States
(12) Patent Application Publication
(10) Pub. No.: US 2005/0010731 A1
(43) Pub. Date: Jan. 13, 2005

(54) Method and apparatus for protecting data against any category of disruptions

(76) Inventors: Stephen H. Zalewski, Pleasant Hill, CA (US); Aida McArthur, Sunnyvale, CA (US)

Correspondence Address: KENYON & KENYON;Suite 600, 333 W. San Carlos Street, San Jose, CA, 95110-2711, US

(21) Appl. No.: 10/616,079

(22) Filed: Jul. 8, 2003

(51) Int. Cl. G06F 12/16

(52) U.S. Cl. 711/162; 714/6

(57) ABSTRACT

A method and apparatus for protecting stored data from both logical and physical disruptions are disclosed. The method may include storing a source set of data on a first data storage medium, with the source set of data designated as a primary data source. A physical replica set of data is created on a second data storage medium for protection against physical disruptions to the source set of data and a logical replica set of data is created for protection against logical disruptions to the source set of data. If the first data storage medium becomes damaged, a processor switches to the physical replica set of data as the primary data source. If the source set of data becomes corrupted, the processor retrieves the logical replica set of data and overwrites the source set of data.

### CROSS REFERENCE TO RELATED APPLICATIONS

This application is related by common inventorship and subject matter to co-filed and co-pending applications titled “Method and Apparatus for Determining Replication Schema Against Logical Data Disruptions”, “Methods and Apparatus for Building a Complete Data Protection Scheme”, and “Method and Apparatus for Creating a Storage Pool by Dynamically Mapping Replication Schema to Provisioned Storage Volumes”, filed Jun. _, 2003. Each of the aforementioned applications is incorporated herein by reference in its entirety.

### TECHNICAL FIELD OF THE INVENTION

The present invention pertains to a method and apparatus for preserving data. More particularly, the present invention pertains to replicating data to protect the data from physical and logical disruptions of the data storage medium.

### BACKGROUND INFORMATION

Many methods of backing up a set of data to protect against disruptions exist. As is known in the art, the traditional backup strategy has three different phases. First the application data needs to be synchronized, or put into a consistent and quiescent state. Synchronization only needs to occur when backing up data from a live application. The second phase is to take the physical backup of the data. This is a full or incremental copy of all of the data backed up onto disk or tape. The third phase is to resynchronize the data that was backed up. This method eventually results in file system access being given back to the users.

However, the data being stored needs to be protected against both physical and logical disruptions. A physical disruption occurs when a data storage medium, such as a disk, physically fails. Examples include when disk crashes occur and other events in which data stored on the data storage medium becomes physically inaccessible. A logical disruption occurs when the data on a data storage medium becomes corrupted, through computer viruses or human error, for example. As a result, the data in the data storage medium is still physically accessible, but some of the data contains errors and other problems.

### SUMMARY OF THE INVENTION

A method and apparatus for protecting stored data from both logical and physical disruptions are disclosed. The method includes storing a source set of data on a first data storage medium, with the source set of data designated as a primary data source. A physical replica set of data is created on a second data storage medium for protection against physical disruptions to the source set of data and a logical replica set of data is created for protection against logical disruptions to the source set of data. If the first data storage medium becomes damaged, a processor switches to the physical replica set of data as the primary data source. If the source set of data becomes corrupted, the processor retrieves the logical replica set of data and overwrites the source set of data.

### BRIEF DESCRIPTION OF THE DRAWINGS

The invention is described in detail with reference to the following drawings wherein like numerals reference like elements, and wherein:

FIG. 1 illustrates a diagram of a possible data protection process according to an embodiment of the present invention.

FIG. 2 illustrates a block diagram of a possible data protection system according to an embodiment of the present invention.

FIG. 3 illustrates a possible snapshot process according to an embodiment of the present invention.

FIG. 4 illustrates a flowchart of a possible process for performing back-up protection of data using the snapshot process according to an embodiment of the present invention.

FIG. 5 illustrates a flowchart of a possible process for protecting a set of data against logical and physical disruptions according to an embodiment of the present invention.

FIG. 6 illustrates a flowchart of a possible process for retrieving a set of data after a logical or physical disruption according to an embodiment of the present invention.

### DETAILED DESCRIPTION OF THE PREFERRED EMBODIMENTS

A method and apparatus for protecting stored data from both logical and physical disruptions are disclosed. A physical replica set of data of a source set of data may be created and stored to protect against physical disruptions. The physical replica set of data may be a dynamic copy of the data stored on a different storage medium from the source of data that adds changes to the stored data in real time. The physical set of data may be stored in a data storage medium that is physically remote from or local to the source set of data. A logical replica set of data may be created and stored to protect logical against disruptions. A logical replica set of data creates a static whole or partial copy of the source set of data to represent a point-in-time (hereinafter, “PIT”) copy. The logical replica set of data may be created from the source set of data or from the physical replica set of data. A processor running a single program may create the physical replica set of data and the logical replica set of data. The processor may be part of, for example, a standalone unit, a storage controller, an application server, a local storage pool, or other devices. Mirroring and point-in-time technologies may be used to create the replica sets of data.

In order to recover data, an information technology (hereinafter, “IT”) department must not only protect data from hardware failure, but also from human errors and such. Overall, the disruptions can be classified into two broad categories: “physical” disruptions, that can be solved by mirrors to address hardware failures; and “logical” disruptions that can be solved by a snapshot or a PIT copy for instances such as application errors, user errors, and viruses. This classification focuses on the particular type of disruptions in relation to the particular type of replication technologies to be used. The classification also acknowledges the fundamental difference between the dynamic and static nature of mirrors and PIT copies. Although physical and logical disruptions have to be managed differently, the invention described herein manages both disruption types as part of a single solution.

Strategies for resolving the effects of physical disruptions call for following established industry practices, such as setting up several layers of mirrors and the use of failover system technologies. Mirroring is the process of copying data continuously in real time to create a physical copy of the volume. Mirrors contribute as a main tool for physical replication planning, but it is ineffective for resolving logical disruptions.

Strategies for handling logical disruptions include using snapshot techniques to generate periodic PIT replications to assist in rolling back to previous stable states. Snapshot technologies provide logical PIT copies of volumes of files. Snapshot-capable volume controllers or file systems configure a new volume but point to the same location as the original. No data is moved and the copy is created within seconds. The PIT copy of the data can then be used as the source of a backup to tape, or maintained as is as a disk backup. Since snapshots do not handle physical disruptions, both snapshots and mirrors play a synergistic role in replication planning.

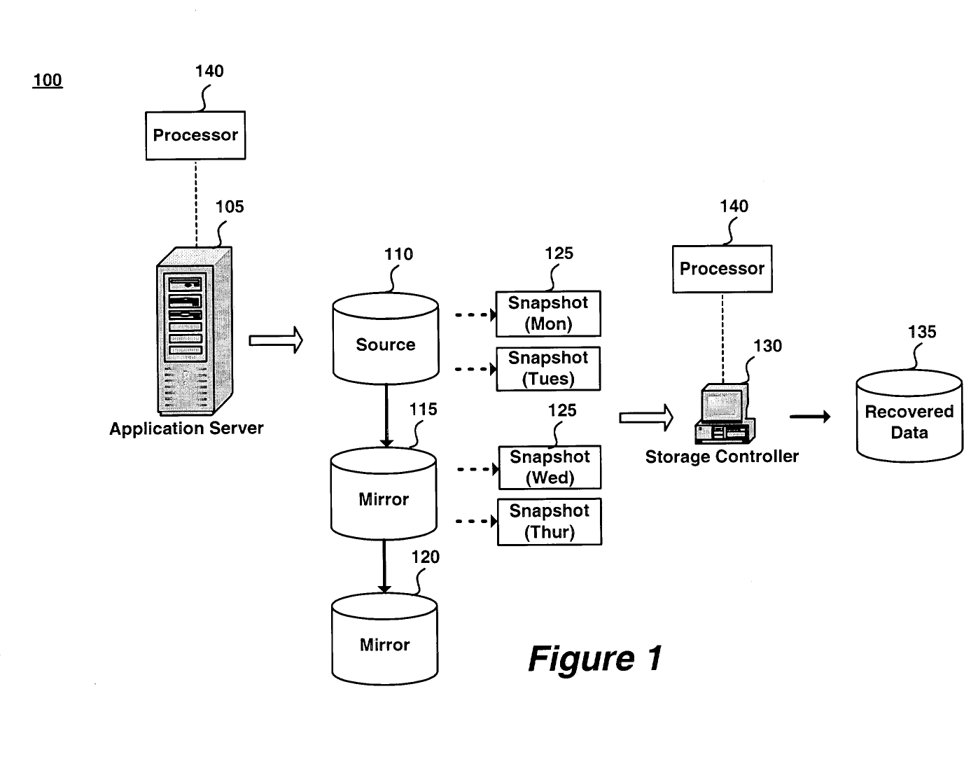

FIG. 1 illustrates a diagram of one possible embodiment of the data protection process 100. An application server 105 may store a set of source data 110. The server 105 may create a set of mirror data 115 that matches the set of source data 110. Mirroring is the process of copying data continuously in real time to create a physical copy of the volume. Mirroring often does not end unless specifically stopped. A second set of mirror data 120 may also be created from the first set of mirror data 115. Snapshots 125 of the set of mirror data 115 and the source data 110 may be taken to record the state of the data at various points in time. Snapshot technologies may provide logical PIT copies of the volumes or files containing the set of source data 110. Snapshot-capable volume controllers or file systems configure a new volume but point to the same location as the original source data 110. A storage controller 130, running a recovery application, may then recover any missing data 135. A processor 140 may be a component of, for example, a storage controller 130, an application server 105, a local storage pool, other devices, or it may be a standalone unit.

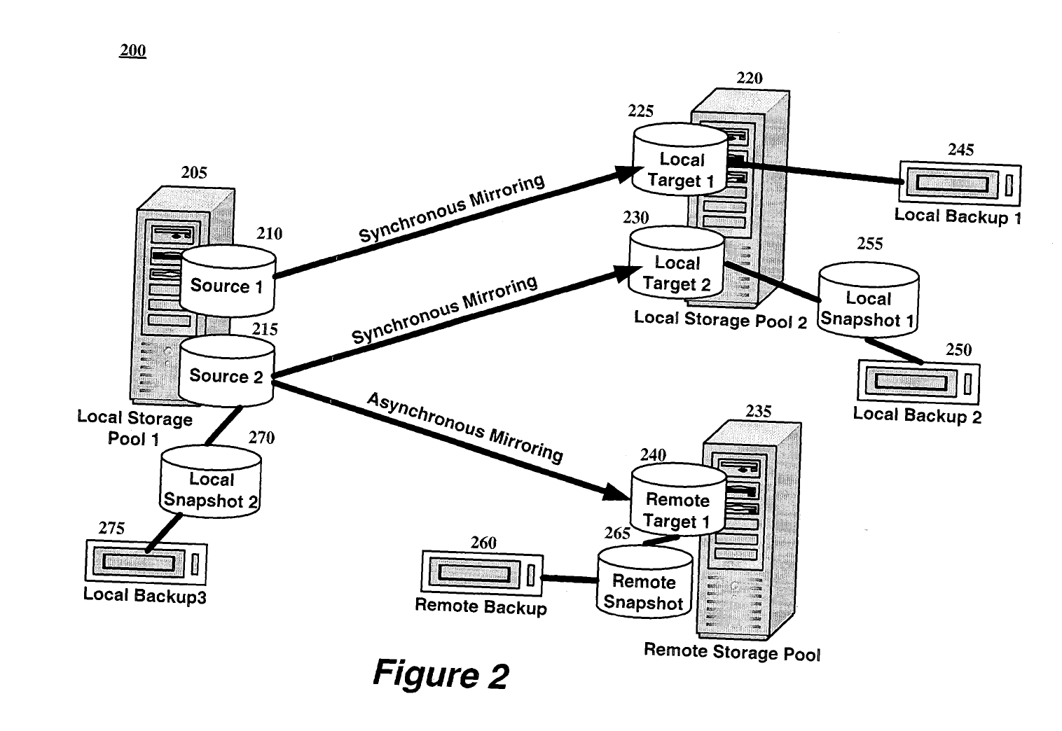

FIG. 2 illustrates one possible embodiment of the data protection system 200 as practiced in the current invention. A single computer program may operate a backup process that protects the data against both logical and physical disruptions. A first local storage pool 205 may contain a first set of source data 210 to be protected. One or more additional sets of source data 215 may also be stored within the first local storage pool 205. The first set of source data 210 may be mirrored on a second local storage pool 220, creating a first set of local target data 225. The additional sets of source data 215 may also be mirrored on the second local storage pool 220, creating additional sets of local target data 230. The data may be copied to the second local storage pool 220 by synchronous mirroring. Synchronous mirroring updates the source set and the target set in a single operation. Control may be passed back to the application when both sets are updated. The result may be multiple disks that are exact replicas, or mirrors. By mirroring the data to this second local storage pool 220, the data is protected from any physical damage to the first local storage pool 205.

One of the sets of source data 215 on the first local storage pool 205 may be mirrored to a remote storage pool 235, producing a remote target set of data 240. The data may be copied to the remote storage pool 235 by asynchronous mirroring. Asynchronous mirroring updates the source set and the target set serially. Control may be passed back to the application when the source is updated. Asynchronous mirrors may be deployed over large distances, commonly via TCP/IP. Because the updates are done serially, the mirror copy 240 is usually not a real-time copy. The remote storage pool 235 protects the data from physical damage to the first local storage pool 205 and the surrounding facility.

In one embodiment, logical disruptions may be protected by on-site replication, allowing for more frequent backups and easier access. For logical disruptions, a first set of target data 225 may be copied to a first replica set of data 245. Any additional sets of data 230 may also be copied to additional replica sets of data 250. An offline replica set of data 250 may also be created using the local logical snapshot copy 255. A replica 260 and snapshot index 265 may also be created on the remote storage pool 235. A second snapshot copy 270 and a backup 275 of that copy may be replicated from the source data 215.

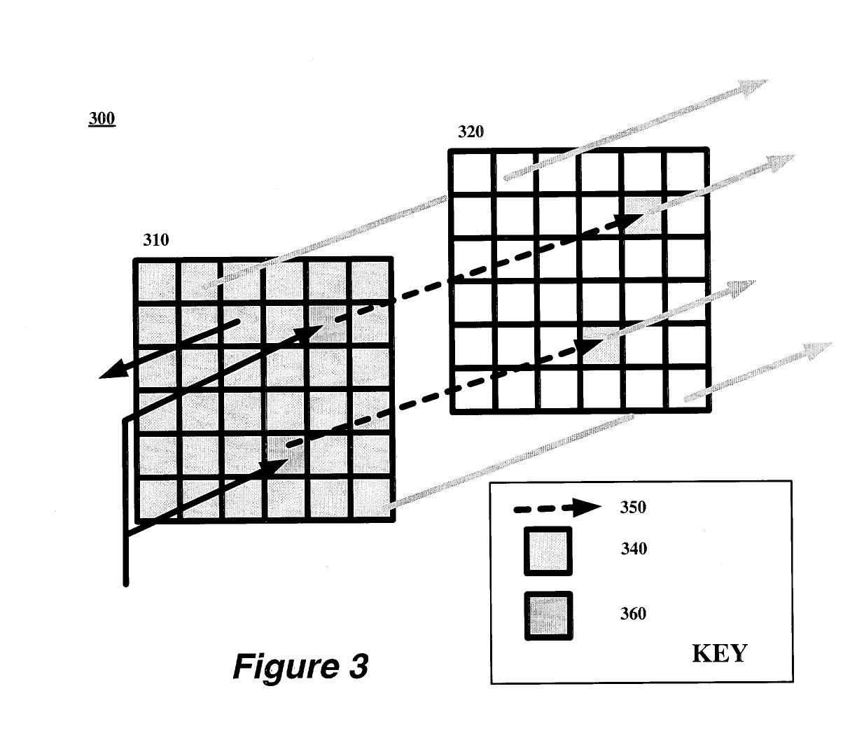

FIG. 3 illustrates one possible embodiment of the snapshot process 300 using the copy-on write technique. A pointer 310 may indicate the location on a storage medium of a set of data. When a copy of data is requested using the copy-on-write technique, the storage subsystem may simply set up a second pointer 320, or snapshot index, and represent it as a new copy. A physical copy of the original data may be created in the snapshot index when the data in the base volume is initially updated. When an application 330 alters the data, some of the pointers 340 to the old set of data may not be changed 350 to point to the new data, leaving some pointers 360 to represent the data as it stood at the time of the snapshot 320.

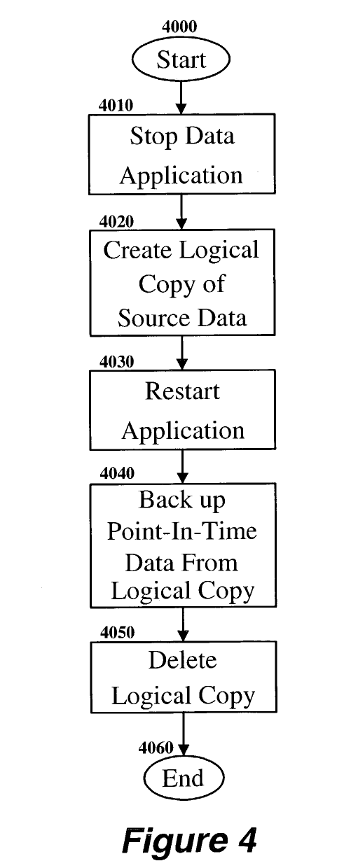

FIG. 4 illustrates in a flowchart one possible embodiment of a process for performing backup protection of data using the PIT process. At step 4000, the process begins and at step 4010, the processor 140, or a set of processors, stops the data application. This data application may include a database, a word processor, a web site server, or any other application that produces, stores, or alters data. If the backup protection is being performed online, the backup and the original may be synchronized at this time. In step 4020, the processor 140 performs a static replication of the source data creating a logical copy, as described above. In step 4030, the processor 140 restarts the data application. For online backup protection, the backup and the original may be unsynchronized at this time. In step 4040, the processor 140 replicates a full PIT copy of the data from the logical copy. The full PIT copy may be stored in a hard disk drive, a removable disk drive, a tape, an EEPROM, or other memory storage devices. In step 4050, the processor 140 deletes the logical copy. The process then goes to step 4060 and ends.

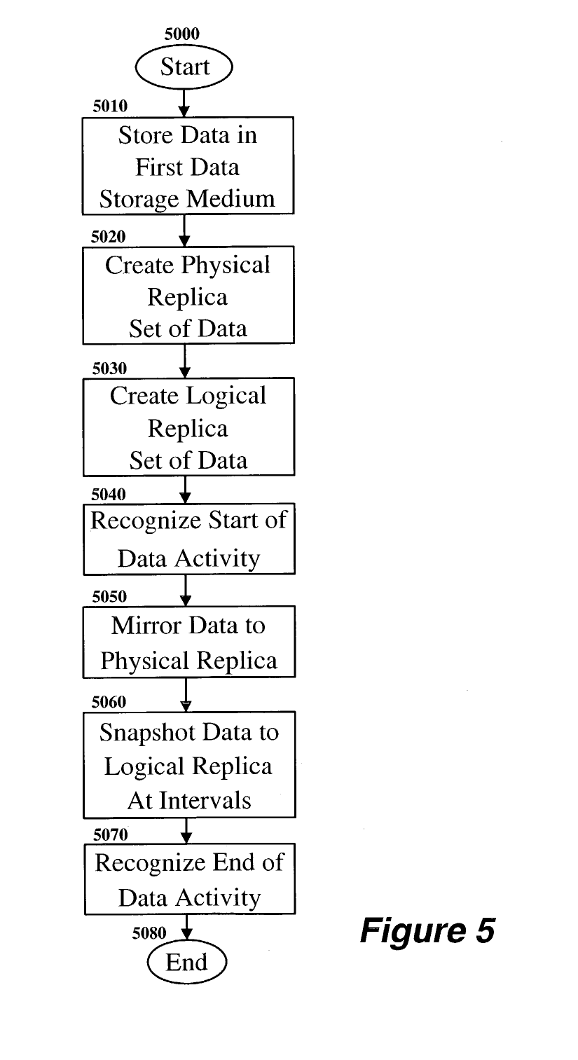

FIG. 5 illustrates in a flowchart one possible embodiment of a process for protecting a set of data against logical and physical disruptions. At step 5000, the process begins and at step 5010, the processor 140 or a set of processors, performing a single program designed to protect against physical and logical data disruptions, stores a source set of data in a data storage medium, or memory. This memory may include a hard disk drive, a removable disk drive, a tape, an EEPROM, or other memory storage devices. In step 5020, the processor 140 copies the source set of data to create a physical replica set of data stored on a second data storage medium to protect against any physical disruption to the data. The second data storage medium may include a hard disk drive, a removable disk drive, a tape, an EEPROM, or other memory storage devices. The second data storage medium may be physically remote from or local to the first data storage medium. The physical replica set of data may be a mirror copy or a copy created by using other copying methods known in the art. In step 5030, the processor 140 further copies the source set of data to create a logical replica set of data to protect against any logical disruption to the data. The logical replica set of data may be created by copying the physical replica set of data or by copying the source set of data. The data may be a PIT copy created by creating a snapshot of the data or by using other copying methods known in the art. Upon the processor 140 recognizing the start of data activity in step 5040, the processor 140 mirrors the source set of data to the physical replica set of data 5050. The mirroring may be synchronous or asynchronous. Data activity may include the creation, editing, or deletion of data by a user or some other entity. In step 5060, the processor 140 updates the logical replica set of data by taking a snapshot or by asynchronous mirroring at a set of time intervals to create multiple PIT logical copies of the data. These intervals may be pre-programmed or set up by the user. After the processor 140 recognizes the end of data activity in step 5070, the process then goes to step 5080 and ends.

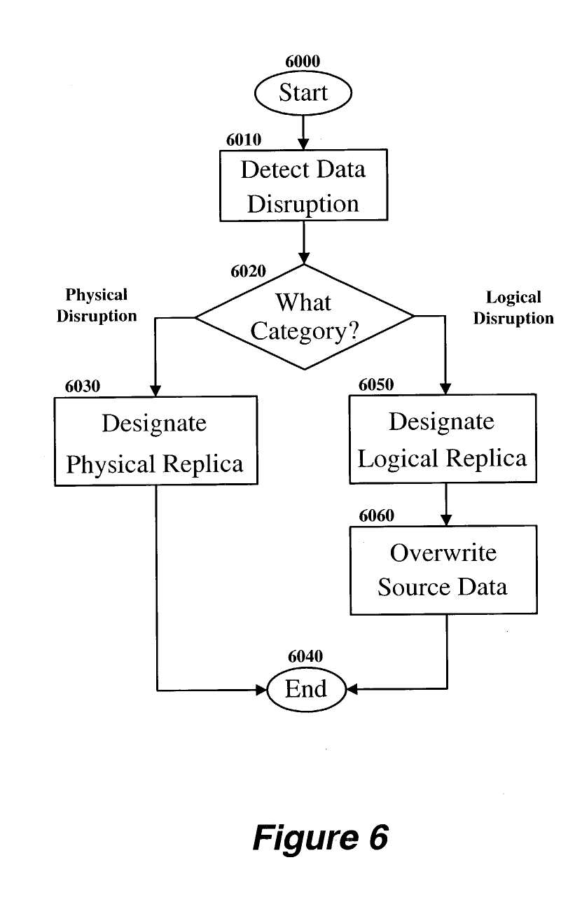

FIG. 6 illustrates in a flowchart one possible embodiment of a process for retrieving a set of data after a logical or physical disruption. The source set of data stored on the first data storage medium may be considered the primary data source. All data activity is initially performed on the primary data source. At step 6000, the process begins and at step 6010, the processor 140 or set of processors, performing a single program designed to protect against physical and logical data disruptions, may detect a disruption to the data process being performed. In step 6020, the processor 140 categorizes the type of disruption that occurred. If the disruption is caused by damage to the data storage medium, the disruption is a physical disruption and, in step 6030, the processor 140 designates the physical replica set of data in the second data storage medium as the primary data source, ending the process in step 6040. If the disruption is caused by corruption of the data, other than corruption caused by damage to the data storage medium, the disruption is a logical disruption and, in step 6050, the processor 140 designates the logical replica set of data as the primary data source. In step 6060, the processor 140 overwrites the source set of data with the logical replica set of data, making the overwritten source set of data the new primary source of data, ending the process in step 6040.

As shown in FIGS. 1 and 2, the method of this invention may be implemented using a programmed processor. However, method can also be implemented on a general-purpose or a special purpose computer, a programmed microprocessor or microcontroller, peripheral integrated circuit elements, an application-specific integrated circuit (ASIC) or other integrated circuits, hardware/electronic logic circuits, such as a discrete element circuit, a programmable logic device, such as a PLD, PLA, FPGA, or PAL, or the like. In general, any device on which the finite state machine is capable of implementing the flowcharts shown in FIGS. 4-6 may be used to implement the data protection system functions of this invention.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

1. A method of protecting stored data, comprising:
storing a source set of data on a first data storage medium;
designating the source set of data as a primary data source;
creating a physical replica set of data on a second data storage medium for protection against physical disruptions to the source set of data;
creating a logical replica set of data for protection against logical disruptions to the source set of data;
if the first data storage medium becomes damaged, switching to the physical replica set of data as the primary data source; and
if the source set of data becomes corrupted, switching to the logical replica set of data as the primary data source.

2. The method of claim 1, wherein the second data storage medium is physically remote from the first data storage medium.

3. The method of claim 1, wherein the second data storage medium is physically local to the first data storage medium.

4. The method of claim 1, wherein the logical replica set of data is a snapshot copy of the source set of data.

5. The method of claim 4, further comprising creating multiple snapshot copies of the source set of data.

6. The method of claim 5, wherein each snapshot copy represents a different point-in-time version of the source set of data.

7. The method of claim 1, wherein the physical replica set of data is a mirror copy of the source set of data.

8. The method of claim 7, further comprising creating the physical replica set of data by asynchronous mirroring.

9. The method of claim 7, further comprising creating the physical replica set of data by synchronous mirroring.

10. The method of claim 1, wherein the logical replica set of data is created from the physical replica set of data.

11. The method of claim 1, wherein the logical replica set of data is created from the source set of data.

12. The method of claim 1, further comprising overwriting the corrupted source set of data with the logical replica set of data.

13. A processing system, comprising:
a first data storage medium that stores a source set of data as a primary data source;
a second data storage medium that stores a physical replica set of data; and
a processor performing a single set of instructions that creates a logical replica set of data for protection against logical disruptions to the source set of data and creates the physical replica set of data for protection against physical disruptions to the source set of data,
wherein, if the first data storage medium becomes damaged, the processor switches to the physical replica set of data as the primary data source; and
wherein, if the source set of data becomes corrupted, the processor switches to the logical replica set of data as the primary data source.

14. The processing system of claim 13, wherein the physical replica set of data is stored in a second data storage medium physically remote from the first data storage medium.

15. The processing system of claim 13, wherein the physical replica set of data is stored in a second data storage medium physically local to the first data storage medium.

16. The processing system of claim 13, wherein the logical replica set of data is a snapshot copy of the source set of data.

17. The processing system of claim 16, wherein the storage controller creates multiple snapshot copies of the source set of data.

18. The processing system of claim 17, wherein each snapshot copy represents a different point-in-time version of the source set of data.

19. The processing system of claim 13, wherein the physical replica set of data is a mirror copy of the source set of data.

20. The processing system of claim 19, wherein the processor creates the physical replica set of data by asynchronous mirroring.

21. The processing system of claim 19, wherein the processor creates the physical replica set of data by synchronous mirroring.

22. The processing system of claim 13, wherein the logical set of data is created from the physical replica set of data.

23. The processing system of claim 13, wherein the logical set of data is created from the source set of data.

24. The processing system of claim 13, wherein the processor overwrites the corrupted source set of data with the logical replica set of data.

25. A set of instructions residing in a storage medium, said set of instructions capable of being executed by a storage controller to implement a method for processing data, the method comprising:
storing a source set of data on a first data storage medium;
designating the source set of data as a primary data source;
creating a physical replica set of data on a second data storage medium for protection against physical disruptions to the source set of data;
creating a logical replica set of data for protection against logical disruptions to the source set of data;
if the first data storage medium becomes damaged, switching to the physical replica set of data as the primary data source; and
if the source set of data becomes corrupted, switching to the logical replica set of data as the primary data source.

26. The set of instructions of claim 25, wherein the second data storage medium is physically remote from the first data storage medium.

27. The set of instructions of claim 25, wherein the second data storage medium is physically local to the first data storage medium.

28. The set of instructions of claim 25, wherein the logical replica set of data is a snapshot copy of the source set of data.

29. The set of instructions of claim 28, further comprising creating multiple snapshot copies of the source set of data.

30. The set of instructions of claim 29, wherein each snapshot copy represents a different point-in-time version of the source set of data.

31. The set of instructions of claim 25, wherein the physical replica set of data is a mirror copy of the source set of data.

32. The set of instructions of claim 31, further comprising creating the physical replica set of data by asynchronous mirroring.

33. The set of instructions of claim 31, further comprising creating the physical replica set of data by synchronous mirroring.

34. The set of instructions of claim 25, wherein the logical set of data is created from the physical replica set of data.

35. The set of instructions of claim 25, wherein the logical set of data is created from the source set of data.

36. The set of instructions of claim 25, further comprising overwriting the corrupted source set of data with the logical replica set of data.
